(19) United States
(12) Patent Application Publication
(10) Pub. No.: US 2010/0100947 A1
(43) Pub. Date: Apr. 22, 2010

(54) SCHEME FOR AUTHENTICATING WITHOUT PASSWORD EXCHANGE

(75) Inventors: Mathieu Ciet, Paris (FR); Michael L. Crogan, Palo Alto, CA (US); Augustin J. Farrugia, Curpertino, CA (US); Nicholas T. Sullivan, Sunnyvale, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/255,315

(22) Filed: Oct. 21, 2008

(51) Int. Cl. H04L 9/32; G06F 7/38

(52) U.S. Cl. 726/6; 708/491

(57) ABSTRACT

Aspects relate to systems and methods implementing a scheme allowing a Verifier (V) to authenticate a Prover (P). The scheme comprises pre-sharing between V and P a graph of nodes. Each node is associated with a polynomial. V sends P data comprising data for selecting a polynomial of the graph, such as traversal data for proceeding from a known node to another node, a time interval, and a number k. P uses the time interval in an evaluation of the polynomial. P then uses the evaluation as a λ in a Poisson distribution, and determines a value related to a probability that a number of occurrences of an event equals k. P sends the determined value to V. V performs a similar determination to arrive at a comparison value. P authenticates V if the separately determined values match, or otherwise meet expectations. The process can be repeated to increase confidence in authentication.

### BACKGROUND

1. Field

The following relates to systems and methods for allowing one entity to authenticate with another entity, and more particularly to systems and methods that allow such authentication without communication of a pre-shared secret between the entities.

2. Related Art

There is a continued need to be able to authenticate parties and/or devices to each other during electronic communications. For example, a prover (P) and verifier (V) can pre-share a password. When V proves its identity (authenticates to P) by providing the password to P.

Another authentication mechanism to verify P to V uses asymmetric encryption keys. This mechanism involves P using a private key of an asymmetric key pair to encrypt a message, then V can use P's public key to decrypt the message. If the message makes sense, e.g., if it is not garbled, or if the message matches a pre-shared message to be used for authentication, then V can authenticate P.

Another category of ways for P to authenticate with V involve using challenge/response protocols where information is transferred between P and V, but the information transferred may allows P to prove possession a given secret to V, without exposing information that would allow an eavesdropper to obtain information that would allow the eavesdropper to impersonate P (i.e., falsely authenticate as P), or a dishonest verifier communicating with P to obtain information that would allow impersonation of P. Such schemes are attractive, because they allow parties to authenticate without exposing a password to eavesdroppers, or much information about the authentication scheme being used. Such schemes also may be attractive because they can be computationally less intensive than asymmetric encryption. So, further developments in these areas are desired.

### SUMMARY

In a first aspect, a method is for authenticating a proving device with a verifying device, and comprises receiving data at the proving device from the verifying device. The method comprises determining from the received data, an interval, an integer k, and graph traversal information. At the proving device, the graph traversal information is used to traverse a graph having a plurality of nodes, from a start node to an end node. Each node of the graph is associated with a respective polynomial. The method comprises evaluating the polynomial associated with the end node at a start and at an end of the interval, and subtracting the evaluation of the polynomial at the start from the evaluation at the end to determine a subtractand. The method also comprises using the subtractand as an argument in a Poisson calculation resulting in a number to be returned to the verifying device, and for use as a basis for determining authenticity of the providing device.

An example of the Poisson calculation performed includes calculating

$$S = \frac{{g}^{- Δ} {Δ}^{k}}{k !} mod p ,$$

where S is the number, p is a prime pre-shared between P and V, and g is a value of order q mod p, where q is prime and q divides (p−1). V also can compute an S according to the same formula, and validate P based on matching S and S′. In other examples, the number sent from P to V can be proportional to (g^{-Δ}Δ^{k}) mod p.

The graph can include N nodes, and each polynomial can have a degree less than or equal to N. The graph traversal information can comprise an ordered list of node switch elements. P can use each node switch element to determine a next node, beginning from the start node as a current node, and can loop by using respective node switch elements to traverse from the current node to a next node until reaching the end node by exhausting the list of switch elements. Variations can include dividing modulo the switch element corresponding to the current node by a number of outward edges from the current node, as well as weighting some edges to be selected more often than other edges.

Other aspects include systems and computer readable media according to one or more of the above described aspects. Still further aspects can include systems, methods and computer readable media for generating and distributing the polynomials, prime numbers, and other information identified in the above-described aspects.

### BRIEF DESCRIPTION OF THE DRAWINGS

FIG. 1 illustrates an identity verifier entity operable to communicate over a communication channel with an identity proving entity;

FIG. 2 illustrates a block-level diagram of an example of constituent components of a system that can be used as one or more of the verifier and identity proving entity of FIG. 1;

FIG. 3 illustrates an example method of establishing aspects of an authentication scheme that can be implemented by the verifier and proving entities of FIG. 1;

FIG. 4 illustrates a graph with nodes and edges that can be used in an authentication scheme according to some examples and aspects described herein; and

FIG. 5 illustrates aspects of a method that comprises steps that can be performed by the verifier and proving entities for authentication schemes according to some of the examples described herein.

### DESCRIPTION

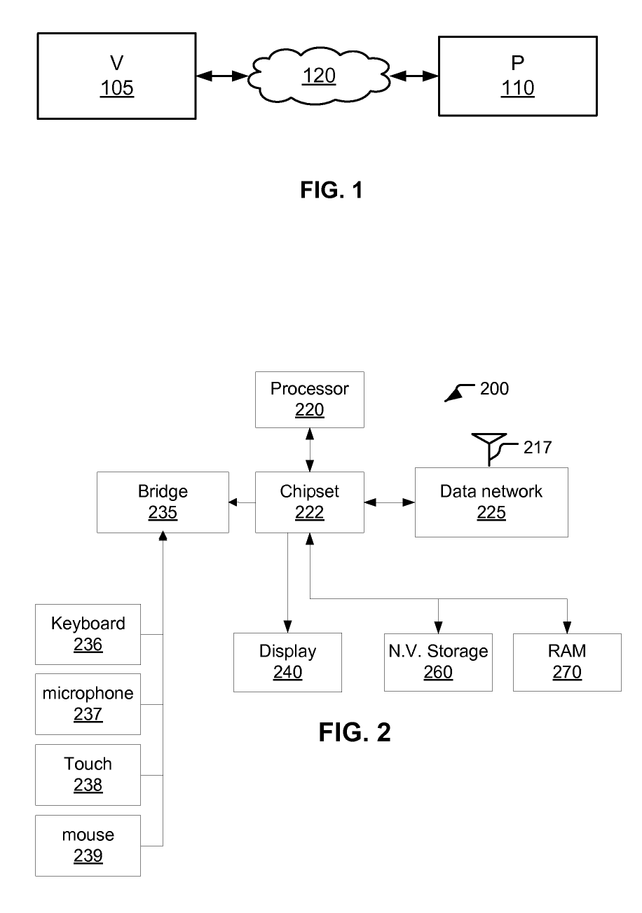

An authentication scheme involves using properties of the Poisson distribution to allow a Verifier (V) to authenticate a Prover (P) by comparing, at V, numbers generated by both the V and P. FIG. 1 illustrates P 110 communicating with V 105 over a communication link 120 that can include communication links including direct connections, such as direct wireless or wired communications, or infrared, ultrawideband technologies, Bluetooth and so on. Such communication links also can include packet networks, and interconnected packet networks, such as the Internet. Such communication links also can include inter-process communications, to allow one process running on a computer to authenticate with another process running on the same computer. These examples show that P and V can be or be composed of any of a variety of entities, and no limitation is intended on P or V based on any exemplary implementation details herein.

FIG. 2 illustrates example components of a system 200 in which can be implemented methods according to the following description. System 200 comprises a process 220 communicating with a chipset 222. Chipset 222 communicates with user interface 235 equipment. Example of such equipment include one or more of a keyboard, a microphone 237 (and potentially other intermediate processing equipment used in voice recognition), touch screen input 238, and mouse input 239. Chipset 222 also includes an interface to a display 240, and an interface to non-volatile storage 260. Non-volatile storage 260 can comprise hard drives, flash drives, optical storage, state-change memory, and any other types of storage that can retain information, often without power consumption.

Chipset 270 also communicates with a random access memory (RAM) 270, which can be used as a working memory during program execution. In some implementations non-volatile storage and RAM can be implemented partially or wholly using the same physical memory resources. In example system 200, chipset 222 also communicates with a data network interface 225 for data communications. Network interface 225 can implement any of a variety of technologies, from short range wireless (e.g., Bluetooth), to local area wireless (e.g., 802.11), to broadband wireless (e.g., Edge, CDMA-W, HSDPA, and so on). Network interface 225 also can comprise wired links, such as IEEE 1394, Ethernet and so on. In some implementations, the interface 225 also can be comprised in the interface to display 240, for example, for DVI or HDMI connections, where authentication may be desired.

Returning now to examples of the authentication proposed here, a Poisson distribution represents a discrete probability distribution that a given number of events will occur in a defined period of time, where the events occur at a known average rate and are independent of each other. A time-homogeneous Poisson distribution is modeled using a parameter λ, which is both the mean and variance of a given Poisson distribution.

With a given constant λ for a time-homogeneous Poisson distribution, a probability that a certain number of occurrences of the event, k, will occur in a defined period of time is determined by equation (1), below, where x is the number of occurrences.

$$P [ x = k ] = \frac{{λ}^{k} {e}^{- λ}}{k !} \qquad Equation 1$$

A time-varying (non-homogeneous) Poisson distribution can be made by providing a time-varying λ, λ(t). Since λ represents an expected mean for a number of events over a period of time, λ(t) is to be integrated over a specified period of time to arrive at a mean, to within a constant, number of events expected in that specified period of time.

$${λ}_{a - b} = {\int }_{a}^{b} λ ( t ) d t \qquad Equation 2$$

λ_{a-b} can then be used in Equation 1 to determine a probability of k events occurring during a time period between a and b.

One way to specify λ(t) is to use a polynomial in a single variable (definitions 1 and 2, below). Such a polynomial can be integrated to arrive at another polynomial that is correct within a constant term, which can be ignored. Also, since it is known that the objective is to integrate the original polynomial for arriving at a λ to use in a Poisson probability calculation, the original polynomial can instead be substituted for its integrand (Equation 3, below), and the integrand can be evaluated at the end points specified, and a subtraction between them can be performed to arrive at a value for λ. Although the Poisson distribution was motivated using time values above, these polynomials can be considered variables in x, more generally, and a notion of identifying a range over which to evaluate an integral of the polynomial does not need to be limited to considering that range to be a range of time.

$$\begin{matrix}λ ( t ) ≡ P ( x ) & Definition 1 \\ F ( x ) ≡ {a}_{n - 1} {X}^{n - 1} + … + {a}_{1} X + {a}_{0} & Definition 2 \\ G ( x ) = \int F ( x ) = \frac{{a}_{n - 1} {X}^{n}}{n} + … + \frac{{a}_{1} {X}^{2}}{2} + {a}_{0} X + {a}_{- 1} & Equation 3\end{matrix}$$

To ensure that G(x) exists, certain coefficients of F(x) (and hence G(x)) can be restricted. In particular, the coefficients aᵢ (i ∈ Z₂₋ₙ) are to be invertible modulo the order of the group. Each aᵢ is invertible modulo the order of the group if there exists a number b such that a·b=1 modulo the order of the group.

In view of the above, the probability of k events occurring in a specified interval, using a variable λ, is given by Equation 4, below, where N(b)−N(a) represents a number of events resulting from the evaluation of the expression on the right.

$$P [ N ( b ) - N ( a ) = k ] = \frac{{( {\int }_{a}^{b} λ ( t ) d t )}^{k} {e}^{- {\int }_{a}^{b} λ ( t ) d t}}{k !} \qquad Equation 4$$

Authentication processes and systems can be implemented based on these concepts. In one aspect, a Prover (P) and a Verifier (V) pre-share a way to select a polynomial from a group of polynomials. V challenges P with an interval (e.g., a beginning and an end for a time period) and a k value. P can produce a probability (or some other number related to the probability), given the selected polynomial and the time period, that the number of events occurring in that period equals k. If P can successfully generate an accurate estimate of such a probability, then it is likely that P has possession of the scheme, and in particular, the polynomial, and is therefore authentic. V can conduct a number of rounds of such challenges to increase confidence in a decision that P is authentic.

So long as the polynomial used in the authentication is not known by an attacker, it would be difficult to be able for an attacker to falsely authenticate to an honest Verifier. However, an attacker may have an ability to gather information about an authentication scheme by repetitively attempting to authenticate and extracting patterns of behavior or other information from which an authentication scheme can be broken.

If only a single polynomial were used in an authentication scheme, then with reasonable computation, and some knowledge about the nature of the authentication scheme, the polynomial could be determined by repetitive interactions of a false prover with an honest verifier. Therefore, it is desirable to provide a way to select a polynomial from a group of polynomials using a selection criteria that also cannot be easily determined. An example way to implement such a polynomial selection mechanism is using a graph of nodes, where the nodes each are associated with a different polynomial, and each node is interconnected with some of the other nodes. Then, by traversing from a known node, using a switching criterion, an end node can be mutually determined. The polynomial associated with that end node can then be used.

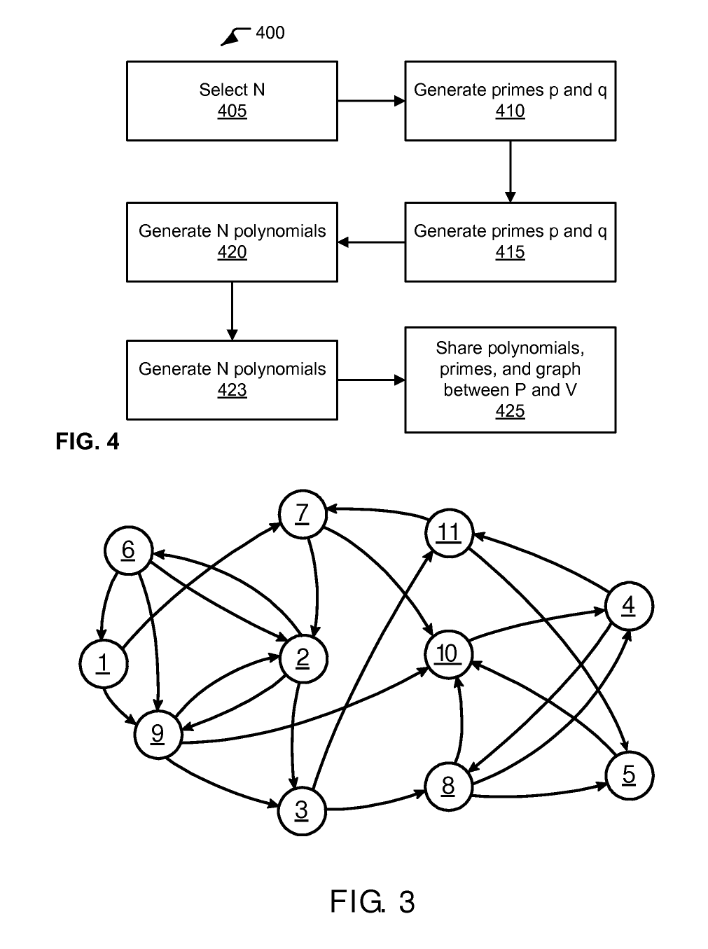

An example graph is shown in FIG. 3 and defined in compact form in Table 1, below. This graph has 11 nodes (N=11), and their interconnection is described as outgoing connections from each node to one or more other nodes.

TABLE 1

| Node | Outgoing Connections |
|---|---|
| 1 | 7, 9 |
| 2 | 9, 3, 6 |
| 3 | 8, 11 |
| 4 | 8, 11 |
| 5 | 10 |
| 6 | 1, 2, 9 |
| 7 | 2, 10 |
| 8 | 5, 4, 10 |
| 9 | 3, 10, 2 |
| 10 | 4 |
| 11 | 5, 7 |

Thus, an example implementation of the authentication scheme uses a graph to allow selection from a number of polynomials. Using a changing polynomial allows a larger number of authentications before the same polynomial is used, which can provide increased authentication security. Examples of ways to select coefficients for such polynomials is described below.

An example of a challenge/response authentication scheme using implementations of graph-based polynomial selection follows. A challenging V and a P can each pre-share a graph description (nodes, associated polynomials, and connectivity between the nodes). V can provide a series of switching instructions to P, indicating a path through the graph to be taken for the present authentication session. The path can be from a starting node that either can be specified, or pre-shared. For example, after a previous successful authentication, a node whose polynomial was used in that authentication can be a starting point for the next authentication.

In a particular example, switching instructions can be provided in a format as follows, assuming that node 2 was the last node used, and hence the start node for a subsequent authentication. V can provide a series of numbers, e.g., {4, 4, 5}. For convenience, this series of numbers is called a switching component, SWC. Each number of SWC ({4, 4, 5}) can be interpreted as a separate node/node transition. The node/node transition for each number can be determined by dividing the number provided modulo a number of edges outgoing from the present node. For example, being at node 2, there are three outgoing edges, so 4 MOD 3 is 1, causing selection of the edge from node 2 to node 3 (edges numbered 0, 1, and 2). Similarly, the second number in the series is 4, and since the current node is now node 3, which has two outgoing edges, 4 MOD 2 is 0, causing selection of the first edge, leading to node 8. The last number in the series is 5, and node 8 (now the current node) has 3 outgoing connections, so 5 MOD 3 is 2, causing selection of the third edge, leading to node 10. Thus, the polynomial used would be the polynomial associated with node 10. Of course, an actual implementation of the graph can be substantially more complicated than the simple example presented here, as explained below. Generally, the graph is cyclic, such that there is no “dead end” node. Edges can loop back to the same node.

Various parameters and aspects of the graph can be adjusted based on needs in a particular implementation. For example, a number of nodes in the graph can be selected according to an amount of security desired, as a graph with more nodes allows more polynomials, and decreases a likelihood that a given polynomial will be repeated, or the frequency with which a given polynomial will be repeated. Also, a larger graph may be used in situations where authentication is expected to be needed for a longer time, and it may be difficult to update one or more of the devices. For example, embedded devices may connect less frequently to a network from which updates can be safely provided.

Aside from a size of the graph, connectivity of the graph can be increased in complexity, making a pattern of polynomial selection (if there is one) more difficult to detect. For example, more edges, on average, between nodes can be provided. Also, a graph can be made undirected, in that any given edge can be traversed in both directions (equivalent to having two edges in opposite directions between each connected node pair).

Node traversal also can be made probabilistic, in that some edges are more likely to be followed from any given node than other edges from that node. A compact way to implement such a probabilistic node traversal is shown by a modification to the node 2 entry of the graph definition of Table 1, above. This entry indicated that from Node 2 any of nodes {9, 3, and 6} could be a next node, meaning that in a random selection, there would be a 1/3 probability of proceeding to any of nodes {9, 3, and 6} from node 2. If it were desired to weight node 9 more heavily, then the node 2 definition can include {9, 9, 3, and 6}, which would cause node 9 to be a next node from node 2 in about ½ of traversals from node 2. Although other ways to implement such a probabilistic weighting are possible, for example by providing a probability associated with each edge, such an implementation require more mathematical calculations during graph traversal, which generally is undesirable. Other selection mechanisms can be incorporated into the graph traversal, such as using a number to pick from a list of polynomials associated with a node (e.g., identifying a node by traversing the graph, then a remaining number provided can indicate an entry of a list).

Thus, principles that can be used in authentication mechanisms according to these disclosures includes pre-sharing information, including using a non-homogenous Poisson process, where the non-homogeneity is provided by a polynomial selected through a graph traversal, as described above. The mechanism can include a challenge/response protocol, where V challenges with graph switching information, start and finish range information, and a number k to be used in the Poisson probability calculation.

In some implementations, a number actually provided from P to V in an implementation can include steps additional or in variation of steps related to Poisson-type probability calculations. An example of a particular implementation follows.

FIG. 4 illustrates a method 400 for establishing an implementation of authentication schemes according to the above description. After describing how an implementation can be established, there follows description how such an implementation can be used.

A number of nodes, N, to be used in a graph can be selected 405. A first prime number, q and a second prime number, p can be generated 410. Prime q has nₚ bits and prime p has n_{q} bits. The number q should divide (p−1) with no remainder. Sizes of q and p (nₚ and n_{q} bits) can be selected; a 160-bit q would be considered acceptable for most circumstances. Table 2 provides an example p and q.

TABLE 2

| Prime | Digits |
|---|---|
| p | 2782131839373224992923912659124135390347722181697411078258383932934663993510 |
| | 702418858278271407374824137203471315210564026251958389837127503865301 |
| q | 1461501637330902918203684832716283019655932542983 |

With the number of nodes, N, defined, method 410 includes generating (415) B polynomials (preferably different from each other). The degree of each polynomial can be fixed or variable. It can be the case generally that the degree of the polynomials used can be up to the number of nodes, N.

The coefficients of each polynomial are to be within the set [symbol] {0, 1, . . . q−1}, where q is the prime selected above. Each polynomial coefficient can be selected at random from [symbol] (i.e., from the integers less than q). These examples were motivated using an F(x), with its coefficients, and integrating F(x) to arrive at a G(x), which can be associated with a node. Hence, G(x) coefficients are related to F(x) coefficients through division by i, where i represents a degree of the variable associated with a given coefficient in F(x). However, since F(x) coefficients can be selected randomly, in the general sense, coefficients for each G(x) also can be selected directly without any division by F(x) coefficients. In other words, the G(x) polynomials can be determined directly, without following the steps in the motivating explanation beginning at F(x).

In the example where each polynomial can be up to degree N, storage of each polynomial would require up to Size_{Q}=N·n_{q} bits and storage of all the polynomials thus would require up to

$${\sum }_{i = 1}^{N} {Size}_{i}$$

bits. Various optimizations can be made to reduce the memory footprint for polynomial storage, including that zero-valued coefficients can be excluded from being allocated storage, which would result in some small savings. The required memory footprint could be further reduced by dividing all coefficients by a known constant, for example 5, which would reduce the number of bits required to represent each coefficient, and hence all the coefficients for all the polynomials.

Then, a graph having N nodes can be defined 420, where edges between the nodes can be selected randomly, so long as there is no node that does not have at least one outgoing edge to at least one other node. The graph can be defined according to the description above. The graph, including the polynomials, p and q can be shared 425 between two or more parties, e.g., P and V, desiring to authenticate with each other.

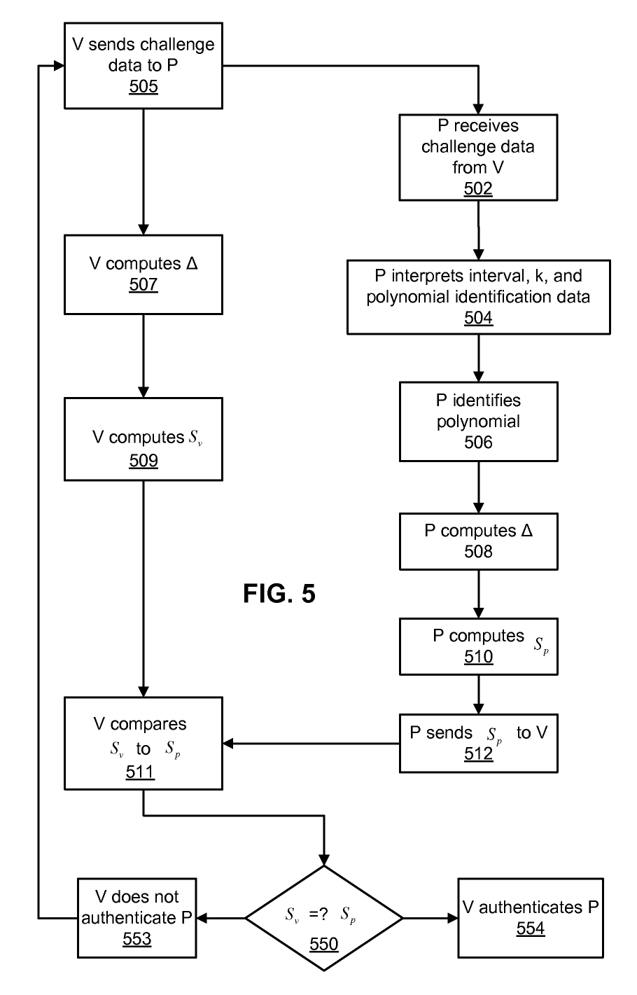

Once the information for performing the authentication has been shared between V and P, authentications can take place, as illustrated with the example steps of method 500 in FIG. 5.

FIG. 5 illustrates that method 500 includes V challenges (505) P with data that P can receive (502) and interpret (504) as a number k, an interval, and polynomial selection information. In an example, the polynomial selection information comprises graph node switching information, as described above. In an example, the interval represents an interval on which a polynomial selected with the node switching information. The interval can be specified with a start point and an end point.

P then identifies (506) the polynomial, identified here as Q(x) , and computes (508) Δ=Q(b)−Q(a) (evaluates the polynomial on the interval provided). P computes (510) its

$${S}_{p} = \frac{{g}^{- Δ} \cdot {Δ}^{k}}{k !} mod p$$

where p and g are as described above. P sends (512) Sₚ (or a value related thereto) to V. V performs corresponding steps 507, 509, and 511 to compute Δ, and Sᵥ. More generally, the S values calculated by V and P can correlate to g^{-Δ}·Δ^{k} mod p, and need not be divided by factorial k and in another example, could be instead divided by another number.

The computation of the S can be done using the principle of joint forms, because the computation involves evaluating an expression where two numbers are raised to powers and multiplied.

Also, the computation of S involves computing g^{-Δ} mod p. This could be done by computing g^{Δ} mod p, and then computing its inverse mod p. This would be inefficient. It would be more efficient to compute −Δ mod q so that the Inverse of Δ=q−Δ (with Δ in {0, . . . q−1}), and then computing g^{Inverse(Δ)}.

V receives Sₚ and compares (550) Sᵥ to Sₚ and if they are determined to correspond, then V can authenticate (554) P, and if not then V can choose not to authenticate (553) P and can repeat the process again by returning to 505. Here, correspond can include determining whether the S values match, match within a range, or otherwise correlate to an expected value. The calculation of S at P also can include randomizing elements.

Method 500 illustrates an example of a looping process where failure to authenticate results in another iteration. In other examples, a plurality of challenges can be issued at once, and P can send S values for each. V can consider each outcome of respective S value comparisons as votes for or against authentication depending on whether the S values match or not.

Methods according to the above-described examples can be implemented using computer-executable instructions that are stored or otherwise available from computer readable media, such as those illustrated as being available or useful in system 200. Such instructions comprise, for example, instructions and data which cause or otherwise configure a general purpose computer, special purpose computer, or special purpose processing device to perform a certain function or group of functions. The computer executable instructions may be, for example, binaries, intermediate format instructions such as assembly language, firmware, or source code. Examples of computer-readable media that may be used to store information used or created during methods according to described examples include magnetic or optical disks, flash memory, USB devices provided with non-volatile memory, as well as networks of storage devices such as NAS or SAN equipment.

Such hardware, firmware and software can also be embodied in any of a variety of form factors and devices, including laptops, smart phones, small form factor personal computers, personal digital assistants, and so on. Functionality described herein also can be embodied in peripherals or add-in cards. Such functionality also can be implemented on a circuit board among different chips or different processes executing in a single device, by way of further example.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims

1. A method for authenticating a proving device with a verifying device, comprising:
receiving data at the proving device from the verifying device;
determining from the received data, an interval, an integer k, and graph traversal information;
using, at the proving device, the graph traversal information to traverse a graph having a plurality of nodes, from a start node to an end node, wherein each node of the graph is associated with a respective polynomial;
evaluating the polynomial associated with the end node at a start and at an end of the interval;
subtracting the evaluation of the polynomial at the start from the evaluation at the end to determine a subtractand; and
using the subtractand as an argument in a Poisson calculation resulting in a number for return to the verifying device, to be used as a basis for determining authenticity of the proving device.

2. The method of claim 1, wherein the Poisson calculation is performed by calculating
$$S = \frac{{g}^{- Δ} {Δ}^{k}}{k !} mod p ,$$
wherein S is the number for return, Δ represents the evaluation of the polynomial, p is a prime pre-shared between the proving device and the verifying device, and g is a value of order q mod p, where q is prime and q divides (p−1).

3. The method of claim 2, further comprising the verifying device also performing the graph traversal, determining
$${S}^{′} = \frac{{g}^{- Δ} {Δ}^{k}}{k !} mod p ,$$
and comparing S′ to S for authenticating the proving device.

4. The method of claim 1, wherein the Poisson calculation determines an S proportional to (g^{-Δ}Δ^{k}) mod p, wherein S is the number for return, Δ represents the evaluation of the polynomial, p is a prime pre-shared between the proving device and the verifying device, and g is a value of order q mod p, where q is prime and q divides (p−1).

5. The method of claim 1, wherein the graph includes N nodes, and each polynomial has a degree less than or equal to N.

6. The method of claim 1, wherein the graph traversal information comprises an ordered list of node switch elements, and the method further comprises the proving device using each node switch element to determine a next node, beginning from the start node as a current node, and looping to use respective node switch elements to traverse from the current node to a next node until reaching the end node by exhausting the list of switch elements.

7. The method of claim 6, further comprising dividing modulo the switch element corresponding to the current node by a number of outward edges from the current node, and using the remainder to determine the next node.

8. The method of claim 1, wherein the graph has characteristics selected from a group comprising cyclicality and directionality.

9. The method of claim 1, wherein the verifying device can challenge a plurality of identity proving devices.

10. The method of claim 1, wherein the proving device can receive challenges from a plurality of identity verifying devices.

11. A system implementing authentication capability between a plurality of devices, comprising:
an identity proving device (P) comprising a computer readable medium storing data comprising a set of polynomials, each polynomial associated with a respective node of a graph, each node of the graph connected to one or more other nodes by respective edges;
an identity verifying device (V) comprising a computer readable medium storing computer readable instructions for causing V to challenge P with an interval, a number k, and graph traversal information, wherein
P is operable to use the graph traversal information to traverse the graph from a start node to an end node, evaluate the polynomial associated with the end node on the interval to produce Δ, and use Δ in determining an S proportional to (g^{-Δ}Δ^{k}) mod p, wherein p is a prime pre-shared between P and V, and g is a value of order q mod p, where q is prime and q divides (p−1), and to send S to V, V being operable to use S in authenticating P.

12. The system of claim 11, wherein P is operable for calculating
$$S = \frac{{g}^{- Δ} {Δ}^{k}}{k !} mod p .$$

13. The system of claim 11, wherein the graph includes N nodes, and each polynomial has a degree less than N.

14. The system of claim 11, wherein V is operable also to perform traversal of the graph, determine an S′ proportional to (g^{-Δ}Δ^{k}) mod p, and compare S′ to S for authenticating P.

15. The system of claim 11, wherein the graph traversal information comprises an ordered list of node switch elements, and P is operable for using each node switch element to determine a next node, beginning from the start node as a current node, and for looping to use one node switch element to traverse from the current node to a next node until reaching the end node by exhausting the list of switch elements.

16. The system of claim 11, wherein P is further operable to determine a number of outward edges from the current node, and divide modulo the switch element corresponding to the current node by that number, using the remainder to determine the next node.

17. The system of claim 11, wherein k is an integer.

18. The system of claim 11, wherein the graph is cyclic.

19. The system of claim 11, wherein the graph is directional.

20. The system of claim 11, wherein V can challenge a plurality of identity proving devices, of which P is one.

21. The system of claim 11, wherein P can receive challenges from a plurality of identity verifying devices, of which V is one.

22. The system of claim 11, wherein P also stores programming for operating as a verifying device.

23. The system of claim 11, wherein P also performs one or more functions including storing digital media, performing digital media, providing e-mail service, providing instant messaging service, providing broadband wireless network access, and providing local area network access.

24. A computer readable medium storing computer readable instructions for a method for a proving device (P) to generate authentication information to send to a verifying device (V), comprising:
receiving data interpretable by P to comprise polynomial selection information for selecting a polynomial from a group of polynomials pre-shared between V and P, a first number, a second number, and a third number;
selecting the polynomial, based on the selection information;
evaluating the polynomial at the first value and at the second value;
determining Δ as a quantity proportional to subtraction of the polynomial at the second value from the evaluation of the polynomial at the first value;
determining S proportional to (g^{-Δ}Δ^{k}) mod p, where p is a prime pre-shared between P and V, and g is a value of order q mod p, where q is prime and q divides (p−1); and
sending S to V, for use in authenticating P.

25. The computer readable medium of claim 24, wherein
$$S = \frac{{g}^{- Δ} {Δ}^{k}}{k !} mod p .$$

26. The computer readable medium of 24, wherein the medium further stores computer readable data interpretable as a graph of nodes, each node being associated with a respective one of the polynomials, and the polynomial selection information includes information for traversing the graph from a starting node to an ending node.

27. The computer readable medium of claim 26, wherein the graph is directed.

28. The computer readable medium of claim 26, wherein the graph includes probabilistic traversal characteristics.

29. The computer readable medium of claim 26, wherein the graph was generated by assigning a different polynomial from a set of polynomials to each node of the graph, and generating, randomly or pseudorandomly, possible walks among the nodes of the graph.
